(19) United States
(12) Patent Application Publication
(10) Pub. No.: US 2023/0089558 A1
(43) Pub. Date: Mar. 23, 2023

(54) SYSTEM FOR CREATION AND DISTRIBUTION OF TARGETED ADS FROM SYNCHRONOUSLY RATED USER GENERATED CONTENT

(71) Applicant: AT&T Intellectual Property I, L.P., Atlanta, GA (US)

(72) Inventors: Ashutosh Sanzgiri, Portland, OR (US); Eric Zavesky, Austin, TX (US); David Crawford Gibbon, Lincroft, NJ (US); Samuel Seljan, Portland, OR (US)

(73) Assignee: AT&T Intellectual Property I, L.P., Atlanta, GA (US)

(21) Appl. No.: 17/481,463

(22) Filed: Sep. 22, 2021

(51) Int. Cl. H04N 21/81; H04N 21/2743; H04L 29/06; H04N 21/472; H04N 21/4784

(52) U.S. Cl. CPC H04N 21/812; H04N 21/2743; H04L 65/4084; H04N 21/47202; H04N 21/4784

(57) ABSTRACT

Aspects of the subject disclosure may include, for example, a device that includes a processing system including a processor; and a memory that stores executable instructions that, when executed by the processing system, facilitate performance of operations of generating a solicitation for an advertisement; determining whether the solicitation meets a brand policy; responsive to the solicitation meeting the brand policy, publishing the solicitation; receiving user generated content (UGC) responsive to the solicitation; receiving feedback concerning the UGC; determining whether the UGC would be suitable as an advertisement based on the feedback; and responsive to the UGC being suitable as the advertisement, publishing the UGC as the advertisement. Other embodiments are disclosed.

### FIELD OF THE DISCLOSURE

The subject disclosure relates to a system for creation and distribution of targeted ads from synchronously rated user generated content.

### BACKGROUND

As digital media and targeted advertising proliferate, the applicability and sourcing of ads has become more complex. First, the authenticity of ads is increasingly important to a product and brand, which may turn to user-based campaigns or user generated content (UGC) to establish a strong user link. Second, the volume of content created for a product is high (in raw UGC) but may lack quality controls or brand alignment. Content created by advertising agencies may lose connections with its target users. Targeted ads are the destination of advertising-based video on demand (AVOD) and casual video delivery systems alike, but current systems fall short of delivering on that promise because of a mostly anonymous user base (e.g., web browser, privacy blockers, etc.).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system to assist in the creation of ad content as a combination of a solicited ad topic or target and user generated content in a platform-managed and policy-managed fashion that functions within the communication network of FIG. 1 in accordance with various aspects described herein.

FIG. 2B is a block flow diagram illustrating an example, non-limiting embodiment of a system to assist in the creation of ad content as a combination of a solicited ad topic or target and user generated content in a platform-managed and policy-managed fashion that functions within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system to assist in the creation of ad content as a combination of a solicited ad topic or target and user generated content in a platform- and policy-managed fashion a system to assist in the creation of ad content as a combination of a solicited ad topic or target and user generated content in a platform- and policy-managed fashion. Other embodiments are described in the subject disclosure. The platform-based system solicits and manages content for an ad goal can reduce the burden of UGC and creation and association while still providing some policies. The system offers improved engagement metrics by targeting from similarity of both creator and consumer (sampling from similar demographics). Additionally, by collecting explicit like/ranking/preference metrics on the UGC content (outside of a final ad product), specific segments of content will be “preapproved” for certain targets, including preference validation.

One or more aspects of the subject disclosure include a device that includes a processing system including a processor; and a memory that stores executable instructions that, when executed by the processing system, facilitate performance of operations of generating a solicitation for an advertisement; determining whether the solicitation meets a brand policy; responsive to the solicitation meeting the brand policy, publishing the solicitation; receiving user generated content (UGC) responsive to the solicitation; receiving feedback concerning the UGC; determining whether the UGC would be suitable as an advertisement based on the feedback; and responsive to the UGC being suitable as the advertisement, publishing the UGC as the advertisement.

One or more aspects of the subject disclosure include a machine-readable medium, comprising executable instructions that, when executed by a processing system including a processor, facilitate performance of operations including: generating a solicitation for an advertisement; publishing the solicitation; receiving user generated content (UGC) responsive to the solicitation; receiving feedback concerning the UGC; determining whether the UGC would be suitable as an advertisement based on the feedback; and responsive to the UGC being suitable as the advertisement, publishing the UGC as the advertisement.

One or more aspects of the subject disclosure include a method of generating, by a processing system including a processor, a solicitation for an advertisement, wherein the solicitation meets a brand policy; posting, by the processing system, the solicitation; receiving, by the processing system, user generated content (UGC) responsive to the solicitation; receiving, by the processing system, feedback concerning the UGC, wherein the feedback comprises user generated comments from one or more of a streaming service and a social media platform; determining, by the processing system, whether the UGC would be suitable as an advertisement based on the feedback; and responsive to the UGC being suitable as the advertisement, publishing, by the processing system, the UGC as the advertisement.

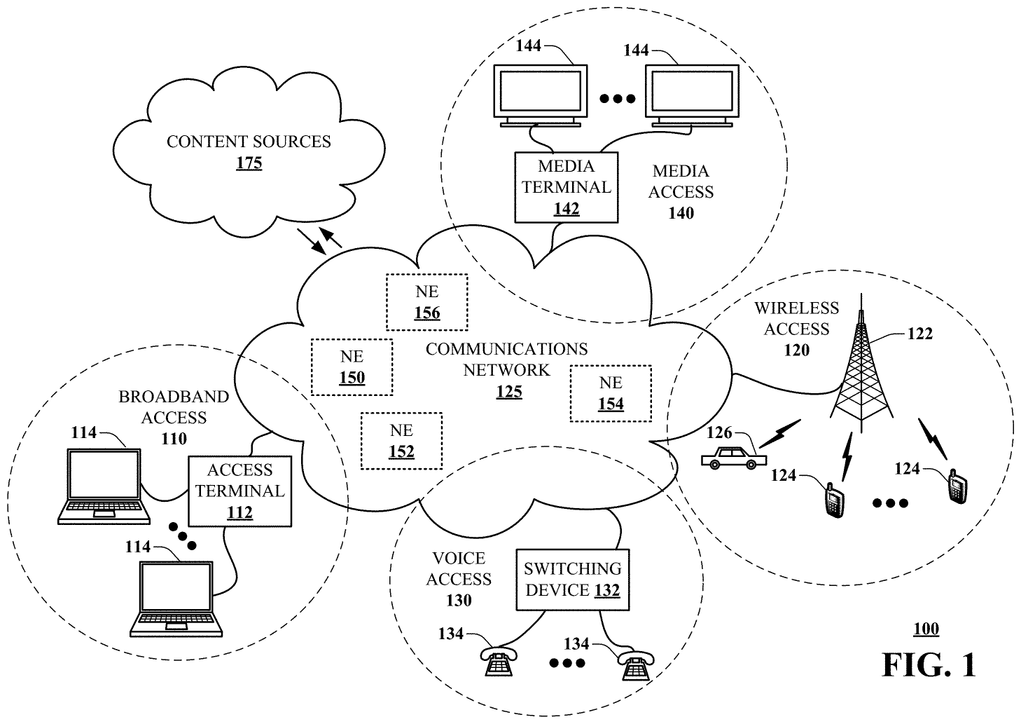

Referring now to FIG. 1, a block diagram is shown illustrating an example, non-limiting embodiment of a system 100 in accordance with various aspects described herein. For example, system 100 can facilitate in whole or in part generating a solicitation for an advertisement, managing brand policies, receiving user generated content (UGC) responsive to the solicitation, receiving feedback concerning the UGC including user generated comments from one or more of a streaming service and a social media platform, determining whether the UGC would be suitable as an advertisement based on the feedback, and publishing the UGC as the advertisement. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

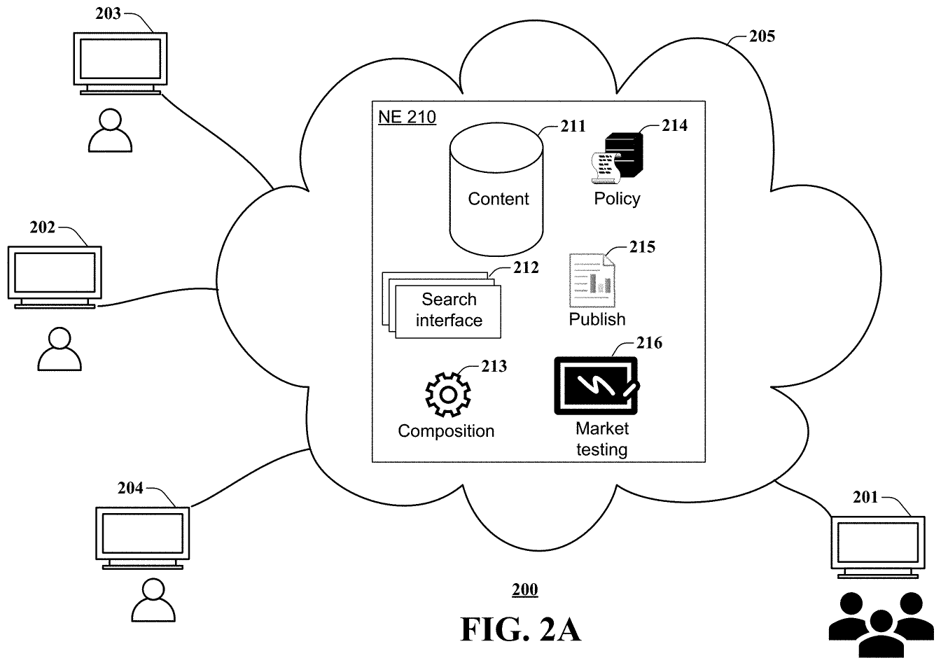

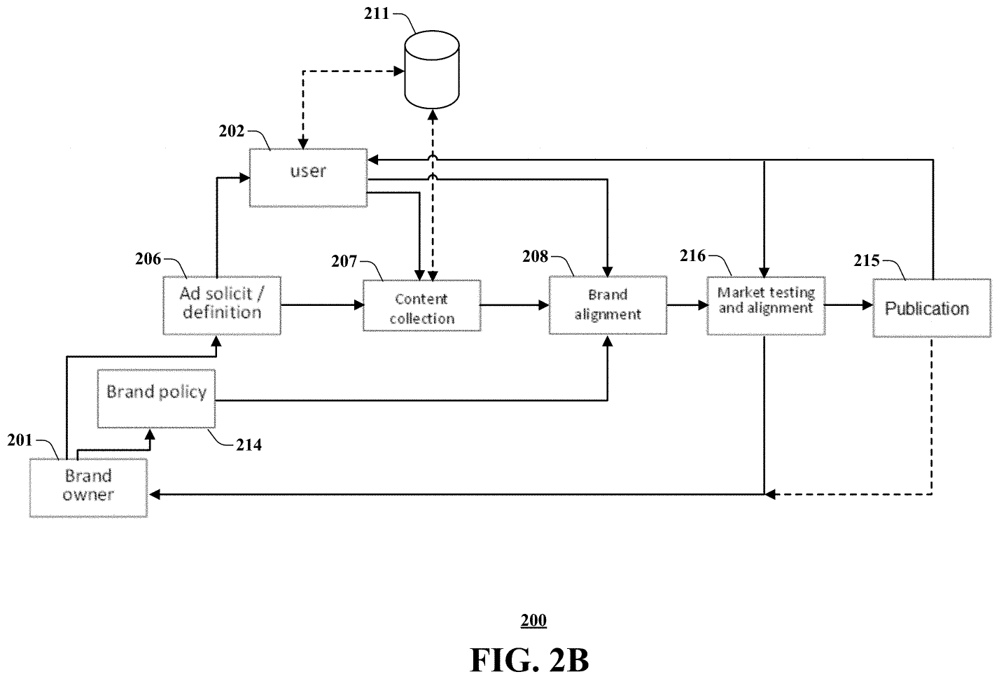

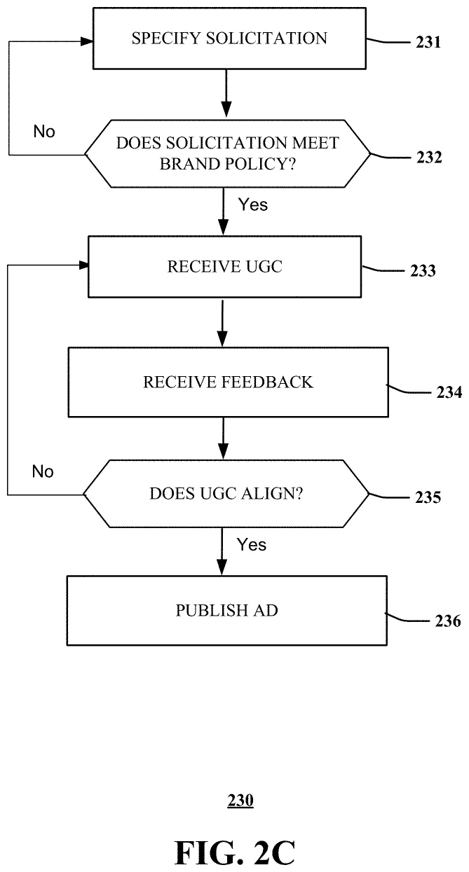

FIG. 2A is a block diagram illustrating an example, non-limiting embodiment of a system to assist in the creation of ad content as a combination of a solicited ad topic or target and user generated content in a platform-managed and policy-managed fashion that functions within the communication network of FIG. 1 in accordance with various aspects described herein. As shown in FIG. 2A, brand owners 201 operate an exemplary computer to securely access network element 210 within communications network 205 to maintain aspects of the operation of network element 210 and implementation of the platform. Users operate media devices 202, 203, 204 to access a fan-based platform implemented by a network element 210. Network element 210 implements a platform to assist in the creation and distribution of UGC for a solicited advertisement. The platform comprises a content database 211, provides a search interface 212, a composition module 213, a policy repository 214, a rendering and publishing module 215, and a market testing and alignment 216 module. Although these platform functions and data storage are illustrated as one single network element 210, one of ordinary skill in the art would realize that such platform functions and data storage may be spread over a distributed computing environment, or even hosted by physical machines outside of the communications network 205, or “network cloud.”

Content database 211 comprises digital media assets that the fans may use or interact within the boundaries of brand owner policies. The platform automatically derives “building blocks” of a branded product that can be used as a basis for creating a UGC advertisement. In one embodiment, a building block may be the appearance of a particular character, a location in an advertisement for the branded product, an extended scene or set of shots, or other memorable or significant narrative object. These building blocks should be recognizable outside of their original source and ideally have a specific preference or attachment to a user measured by explicit indicators (likes, comments, social media) or by passive indicators (most of the content exposure in a series or season focuses on this character or locale). The platform can generate metadata that maintains the original context of these building blocks such that the building blocks may be more easily discovered and evaluated for continuity and fitness in future placements. In one embodiment, the fitness of a building block that involves a famous advertisement character and a quote may represent easily recognizable content associated with the advertised product.

Interface 212 provides the users with notifications of an advertising campaign. This interface may embody more traditional uses (like a search interface with keywords, vocal prompts, visual examples, etc.) or non-traditional examples, like the threading of topics or themes (e.g., an introspective theme or the topic of dealing with the loss of a beloved pet). The interface is designed to allow interactions both with the user as well as automated queries that may be utilized to match candidate segments with building blocks.

A composition module 213 enables fans to fulfill the advertising solicitation with UGC. Composition module 213 provides both textual and visual interfaces to allow fans to express their needs in any form. Some examples of an interface for the composition module 213 may include direct forms, list selections, and graphical indicators (e.g., circles, groupings, highlights) to more complex visual indicators like sliders representing one extreme or another of two oppositional concepts (action vs. drama) or visual components of building blocks (e.g., a haunted mansion or a dark cave). While these are only a few examples, due to the immersive nature of the search interface 212 and composition module 213, more of the interface may focus on the resultant advertising content mash-up (e.g., visual or audio results of the building block and candidate set mixing) instead of the metadata that describes those components. In another embodiment, one or more completed compositions (e.g., those that involve the inclusion of multiple building blocks as suggested by a fitness evaluation from the system) may be presented to the user and thereby limit options to either the completed composition A or completed composition B.

Policy repository 214 stores brand policies governing the use of branded content. Brand owner policies control sharing and discovery of original content. The policies prevent improper usage of original content, appropriate moderation, and distribution of a brand advertisement in a user-based mash-up/composition. Community-based policies provide for different, novel social channels. Policies can be enforced with linkage to a brand at different granular levels, such as object, character, or scripts.

Rendering and publishing module 215 is a mechanism that executes the proposed composition according to policies in policy repository 214. Some embodiments may include the visual splicing of certain characters into unusual scenes, the substitution of a scene or location for another, modification of lighting, dialog replacement between characters, etc. Rendered UGC may be delivered as a single, atomic stream (e.g., a fixed video or audio asset that can be delivered outside of the system), as a series of playlist edits (e.g., jumping from one historical piece of content to the next as determined by time signatures and sources references) or as a complex hybrid of both types, where both the timing of content is specified as well as the effect or composition method (e.g., splice, overlay, replace, fade, etc.).

Market testing and alignment 216 provides automated and community-based checking at publication of new UGC, both for each consuming user (e.g., child, friend, industry pro) and a consumption channel (e.g., social sharing, personal collection, national film release, etc.). In one embodiment, the leaderboard is a scoring mechanism that can rank-order and recommend new combinations of UGC. For example, if a particular dialog exchange was funny or the interaction of multiple characters was exciting, users may express preferences, tags, or otherwise annotate the generated media. The leaderboard can aggregate these preference indicators for an entire duration of newly composed UGC, the candidate segments, or building blocks (both from content database 211). In this manner, repeated use of an original content may naturally formulate a social “meme” through aggregated preference indicators. In another embodiment, the leaderboard may stratify the preference indicators by demographics or properties associated with the user. For example, one rendering of the leaderboard may represent the entire population of the state of Washington but another rendering may show aggregations for high-school aged users alone.

FIG. 2B is a block flow diagram illustrating an example, non-limiting embodiment of a system to assist in the creation of ad content as a combination of a solicited ad topic or target and user generated content in a platform-managed and policy-managed fashion that functions within the communication network of FIG. 1 in accordance with various aspects described herein. System 200 provides an ability to solicit to a loyal fanbase or celebrity creator set starting with ad seed content. The system 200 can be given seed concepts to inspire parts or whole themes for a new ad spot/campaign. The system 200 offers improved trust or brand-appreciative/authentic content for the creation of UGC. The system 200 reduces a burden for creation and injection of ad UGC with a managed mashup/creator platform that allows users to select from seed audio, video, image brand assets to be included in a campaign. The system 200 provides machine learning (ML) based detection of ideal cut-points given a user target via content similarity (e.g., matching colors, semantic content, etc.) for where to cut in one or more UGC from the wider library. The system 200 uses ML or artificial intelligence (AI) adaptation of content for specific brand. The system 200 improves ad targeting from similarity of both creator and consumer by sampling from similar demographics for creator and target. The system 200 enables highly targeted ads in both location and delivery inventory (explicit feedback/engagement) from very large pools of source content.

As shown in FIG. 2B, a system 200 enables a brand owner 201 to specify a solicitation 206 for an ad spot and provide seed content for consideration of user 202 who creates UGC. The system 200 helps with template and guidance for user submissions. The system 200 enables a brand owner 201 to create a brand policy 214 as well. The system 200 ensures that the solicitation meets brand policy 214 before being forwarded.

In an embodiment, the system 200 can create a mashup of user content (e.g., prior creations or social media posts) to entice user 202 for an initial cut. In an embodiment, system 200 can apply content conditioning or brand stamping more actively instead of a similarity/mapping process alone. For example, content conditioning may be realized as applying one or more policies from the policy repository 214 to bias selection of content for a happy sentiment from a dialog, a silly visual effect on all characters, or a business-setting and dramatic audio for product demonstrations. Brand stamping is a summary term for affecting visual or audio content so that it always contains a logo or jingle. Brand stamping may similarly be enforced by one or more policies from the policy repository 214 to make, for example, an otherwise generic ad to contain magical creatures specific to the entertainment franchise required by the brand owner 201. Both of these examples may be acted upon during any stage of the system execution, but these operations are also contained within brand alignment 208 for simplification. In an embodiment, the solicitation 206 may be triggered by current events (e.g., a notable sporting event may be used to trigger the solicitation, thereby prompting users to create an ad). The solicitation 206 may specify a marker or region to be replaced (e.g., ad soliciting a “soundtrack” which can be come from user content). In an embodiment, the solicitation 206 specifies a deadline for the UGC ad content (e.g., as in a contest or because of a triggered solicitation requiring a short deadline). In an embodiment, the system 200 may alert the brand owner 201 for new trending videos that have their brand or item mentioned; instead of the brand owner 201 initially starting a new campaign and soliciting content. The content may come to the brand owner 201 via an automated alert after a popularity surge. In an embodiment, system 200 allows a user 202 to specify specific target regions or contributions: e.g., specific audio request, specific video or image examples, etc. The system 200 can also provide a library of content 211 to inject. In an embodiment, system 200 may allow brand input and safety to be applied to the solicitation for new content (e.g., colors, specific placement of content, etc.). Initial submissions may have some requirements (e.g., 5 seconds, with 3 seconds showing the main product) for acceptance into the program. The brand owner 201 may provide a skeleton or example to inspire user 202. During ad solicitation 206, a fully automated initial submissions process may be driven by this ad seed or skeleton and can be checked against previously contributed content 211 from the user 202. In another example, instead of a specifically created ad seed, a content example from an ad agency may be used. In both examples, the system constructs an initial UGC submission list after executing a computer vision analysis and comparison between the UGC and content from the brand owner 201. In another example, during ad solicitation 206, the system 200 scans existing sets of UGC to see if passive campaigns have been created (e.g., starting a new “snowboard challenge”), where these passive campaigns were organically based on popular submissions and trends, but are highly relevant to the newly defined ad seeds.

A user 202 who has subscribed to system 200 and follows a specific brand or content creator of the brand owner 201 will see the new ad request. The brand owner 201 may target the ad request by interest to specific users that have posted similar content, or by alerts they have posted, or through a brand ambassador (not illustrated). A user 202 can get special badges or compensation and become a local brand ambassador (e.g., gig economy leaning). In an embodiment, system 200 may compensate both the content creators as well as the reviewers (solicited later in market testing and alignment 216) with incentives. Such incentives may help to develop a social buzz surrounding a branded product. In an embodiment, this set of users can be limited to a specific distribution channel or a specific asset. In an embodiment, users can continuously submit their UGC to a “fan” site (e.g., posting a mashup of content for a superhero character or a specific location in a city) for collection 207 or such UGC can be stored in a library of content 211. In an embodiment, users can consult popular UGC creator sites (e.g., work for hire websites like Mechanical Turk, Fiverr, etc.) to help with the UGC creation process. User 202 submits content, either through an indirect response (i.e., social media or in-app ask, e.g., re-tweet) for the ad campaign or the response could be limited by submission through a specific platform.

Submissions may be restricted by associated activity, where a user has recently watched content or brand (e.g., there is a purchase or view history for the user). In one example that limits user 202 selection to require an activity, such as a stronger, more recent connection to the brand that may be guaranteed through product purchases or brand loyalty. In another example that limits user 202 selection, the brand owner may seek UGC from users that are unfamiliar with a brand's recent ad campaigns or products to get a more objective, “outsider” opinion that may be shared by previous non-customers and thus is otherwise unavailable to those with stronger product loyalties. System 200 may analyze submitted UGC to check for brand alignment 208 with certain seed/brand asset locations (e.g., same color, same activity, etc.). The user 202 may include testimonials with a specific product. The user 202 may include stock imagery, sound, video or dialog semantics specifically with brand or containing high similarity to a brand and the created ad campaign UGC added to the collection 207. Specific activity, speed, tone, of the content to be aligned to requirements specified during solicitation 206 or the content alignment may occur actively during brand alignment 208 according to brand policies 214 defined by the brand and brand owner 201.

User 202 provides feedback through multi-channel market testing and alignment 216 (e.g., multi-channel market testing is performed across multiple display devices, locations, demographics, and media formats like audio, video or images) in response to one or more published 215 versions of the content for ranking. Using the publishing module 215, the system 200 first applies automated rules for filtering content by user alignment to market testing and alignment 216, which may include content moderation. During this filtering, there is an opportunity for personalization of ad sub-chunks according to a user profile. Here, a sub-chunk may be a single sound, word, or visual, or it may be a slightly longer visual action, dialog utterance, or visual shot. In one example, these ad sub-chunks are derived from slight perturbations of highly similar UGC from collection 207. In another example, these ad sub-chunks are derived from seeds provided during solicitation 206 and chosen to be highlighted or tested for feedback by brand alignment 208. Not shown in FIG. 2B, various parts of a user 202 profile may include demographic information, prior ad feedback, purchases made with a brand or category of brand, etc. These profile values may be utilized to personalize the ad sub-chunks such that one ad sub-chunk is chosen to better align with user preferences and further improve engagement with the ad campaign. The system 200 harnesses not only explicit feedback from the current multi-channel market testing evaluation, but also long-term profile alignment against the market testing and alignment 216 of previous campaigns. These previous campaigns may have been defined by the same brand owner 201, may have been discovered during solicitation 206, or may have been identified through metadata logging of the UGC itself and discovering that one or more unique pieces of content from user 202 has been utilized in similar ad campaigns.

Additional insights from the feedback help to inform both the brand owner 201 (i.e., for demographic alignment of the brand to the users) as well as the system 200 (for users that generate responses to the solicitation).

Feedback may be solicited by viewing UGC clips included in the collection 207 managed by the system or by view of arbitrary UGC clips in a social platform. In one example, feedback of UGC clips may define an affinity graph (e.g., one clip is preferred by user group A and another clip is preferred by user group B, but both clips are preferred by user group C). In another example, a general category of UGC clips may be defined (e.g., cute children of Ohio, silly pet tricks, or comedic graphic novels about postal services). In yet another example, certain feedback may be more valued than other feedback, such as feedback from users 202 that are participants of the new campaign added to collection 207 or those that may have expressed alignment or purchase loyalty to a specific brand owner 201.

The system 200 can utilize in-channel capabilities to infer feedback, like engagement time (e.g., how fast the user 202 swipes away). Other behavioral preference indicators within a platform, like watching to completion, providing visual or spoken feedback, or sharing may also be utilized as direct or indirect feedback within the system 200.

Feedback may be collected by viewing the ad and spliced in UGC clips (like AVOD or traditional streaming services). Although these channels may be more linear in nature (Typically a user is engaged for 8-10 minutes in short form content or longer than 20 minutes in long form content), the behaviors corresponding to skipping, engagement, and other activities may be aggregated for feedback. Typically, this feedback may be less discriminative than other channels because specific preferences for the ad solicitation 206 that may be diluted by other overall preferences for the content itself or the context of the ad in the video stream.

Feedback collected from a streaming service may accommodate active/passive feedback (e.g., allowing skipping easily), changing channel, etc. In one example, a streaming service may allow an ad to specify whether it may be skipped or not. Thus, when the ad plays to completion, the ad is an indicator of a neutral to strong positive preference. In another example, a streaming service may allow skipping or format changing (e.g., switch to audio only or still-frame only) of an ad only after watching a longer series of other ads (e.g., watch one minute of ads in order to skip up to three ads in the future). In this example, preference inference is more complicated because it must also be attentive to exposure saturation and the context of other related (or non-related) ads. The system may be designed to automatically accommodate these format changes or the system may ask for more explicit feedback from the user before allowing a skip or as a follow-up second check after the primary asset in the streaming service has completed.

Both market tests allow designated market areas (DMA) market testing and alignment 216 and demographic analysis. Market testing and alignment 216 provide the system with critical insights that drive which portions of the UGC ad (e.g., an entire ad, a sub-chunk, a specific UGC from a certain user 202 or pre-specified content from the brand owner 201) may be included for final distribution and publication 215. In one example, those portions may vary based on demographic properties of the user 202 and the distribution channel. In another example, portions may vary based on the context of the ad (streaming, social, etc.) and the position of the ad in the publication 215. In all examples, market testing provided by the system is an advantage over traditional advertising feedback and distribution systems, because preferences (and therefore engagement with the ad) have been precisely tested against similar user groups (cohorts) before final format generation (e.g., length, which clips to include, etc.) and before final distribution (e.g., to specific markets, formats, etc.).

The system 200 stitches the final ad into an ad inventory publication 215. The stitching may include AVOD for real-time placement. This starts a continuous loop for feedback in the viewing platform or on other traditional streaming (digital, AVOD). The feedback can be provided through an explicit response or an activation code. Micropayments may be issued to post-release+inclusion of UGC clip in an advertisement. In an embodiment, UGC could be associated with brand/badge points, whether accepted or not.

FIG. 2C depicts an illustrative embodiment of a method in accordance with various aspects described herein. As shown in FIG. 2C, the method 230 begins in step 231, where a brand owner provides specifications for an advertising campaign. In step 232, system 200 checks the solicitation to ensure that it meets brand policies provided by the brand owner. If not, then the method reverts to step 231 where the brand owner modifies the solicitation to meet its own policies.

If the solicitation meets brand policies, then the process continues at step 233 where system 200 prompts users to provide UGC in response to the solicitation. System 200 receives the UGC provided by users. Next, system 200 checks the UGC for alignment with the brand, as described in more detail above. The process continues to step 234, where market testing occurs. As described above, the community of users decide whether the UGC is properly aligned with the brand. In an embodiment, the system may promote a contest to determine the best UGC from among the UGC received in response to the solicitation. Next, in step 234, system 200 checks whether the UGC is properly aligned to the brand based on the feedback received from the community. If the UGC is not properly aligned, then the process repeats at step 233. In an embodiment, the system 200 may provide said feedback to the user creating the UGC, so that the user can make changes.

If the UGC is properly aligned, then the process continues to step 236, where the system publishes the UGC as an advertisement. In an embodiment, system 200 may reward the user creating the UGC. In another embodiment, system 200 may provide the UGC to the brand owner for later publication as an advertisement.

While for purposes of simplicity of explanation, the respective processes are shown and described as a series of blocks in FIG. 2X, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

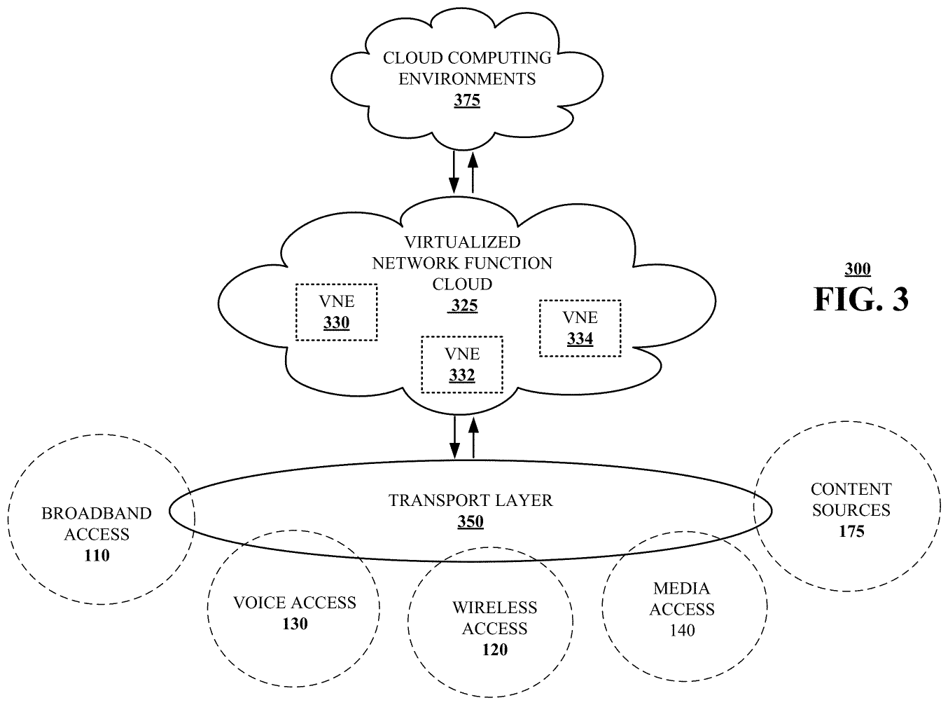

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part generating a solicitation for an advertisement, managing brand policies, receiving user generated content (UGC) responsive to the solicitation, receiving feedback concerning the UGC including user generated comments from one or more of a streaming service and a social media platform, determining whether the UGC would be suitable as an advertisement based on the feedback, and publishing the UGC as the advertisement.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and that creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

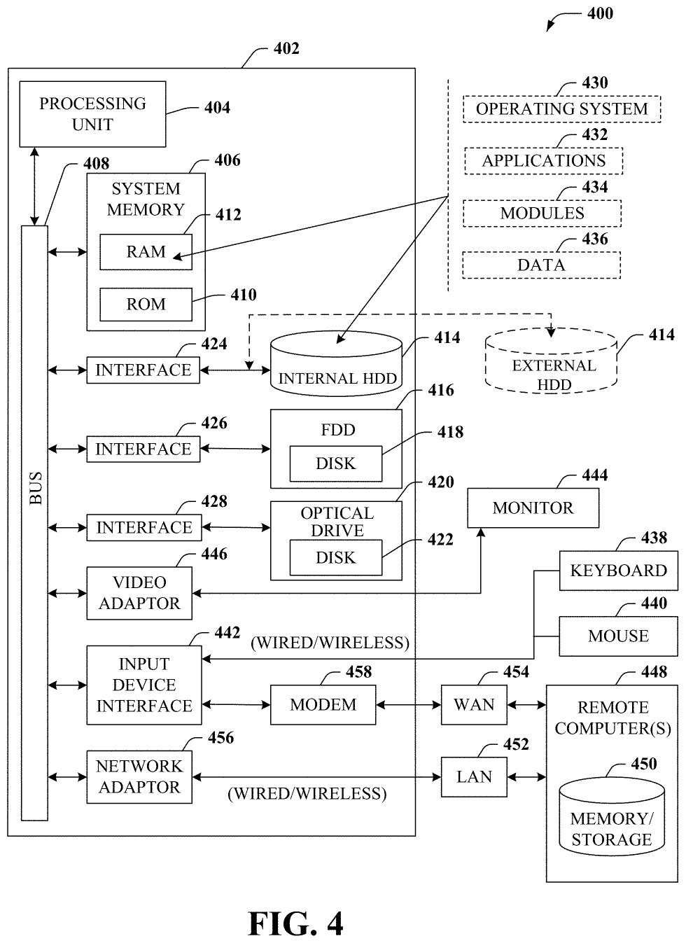

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generating a solicitation for an advertisement, managing brand policies, receiving user generated content (UGC) responsive to the solicitation, receiving feedback concerning the UGC including user generated comments from one or more of a streaming service and a social media platform, determining whether the UGC would be suitable as an advertisement based on the feedback, and publishing the UGC as the advertisement.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

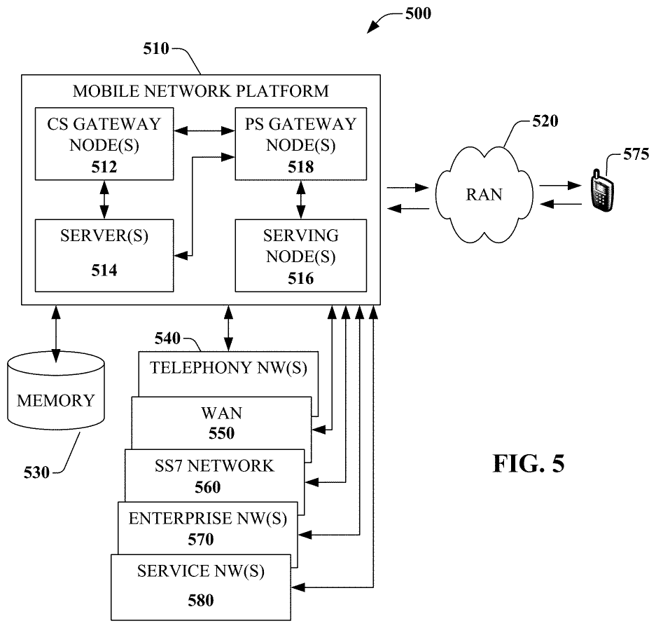

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generating a solicitation for an advertisement, managing brand policies, receiving user generated content (UGC) responsive to the solicitation, receiving feedback concerning the UGC including user generated comments from one or more of a streaming service and a social media platform, determining whether the UGC would be suitable as an advertisement based on the feedback, and publishing the UGC as the advertisement. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

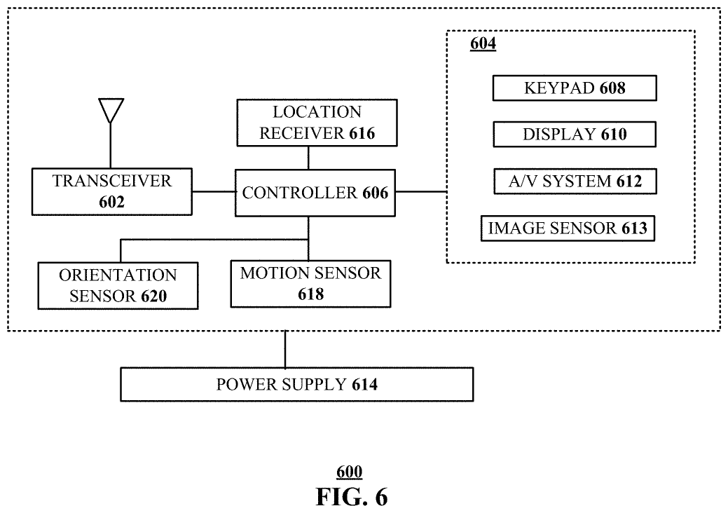

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generating a solicitation for an advertisement, managing brand policies, receiving user generated content (UGC) responsive to the solicitation, receiving feedback concerning the UGC including user generated comments from one or more of a streaming service and a social media platform, determining whether the UGC would be suitable as an advertisement based on the feedback, and publishing the UGC as the advertisement.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
generating a solicitation for acquiring an advertisement for a brand;
determining whether the solicitation meets a policy associated with the brand to which the advertisement is related;
responsive to the solicitation meeting the policy associated with the brand to which the advertisement is related, publishing the solicitation;
receiving user generated content (UGC) responsive to the solicitation;
receiving feedback concerning the UGC;
determining whether the UGC would be suitable as an advertisement based on the feedback; and
responsive to the UGC being suitable as the advertisement, publishing the UGC as the advertisement.

2. The device of claim 1, wherein the feedback is derived from market testing.

3. The device of claim 2, wherein the market testing is determined in designated market areas.

4. The device of claim 1, wherein the feedback comprises content moderation.

5. The device of claim 1, wherein the feedback provides a ranking of the UGC.

6. The device of claim 1, wherein the operations further comprise gathering the feedback from a streaming service.

7. The device of claim 1, wherein the operations further comprise gathering the feedback from a social media platform.

8. The device of claim 1, wherein the advertisement is published to a video on demand service.

9. The device of claim 1, wherein the advertisement is published to a social media platform.

10. The device of claim 1, wherein the operations further comprise providing a reward to a user creating the UGC.

11. The device of claim 1, wherein the processing system comprises a plurality of processors operating in a distributed computing environment.

12. A non-transitory machine-readable medium, comprising executable instructions that, when executed by a processing system including a processor, facilitate performance of operations, the operations comprising:
generating a solicitation for acquiring an advertisement for a brand;
publishing the solicitation if the solicitation meets a policy associated with the brand to which the advertisement is related;
receiving user generated content (UGC) responsive to the solicitation;
receiving feedback concerning the UGC;
determining whether the UGC would be suitable as an advertisement based on the feedback; and
responsive to the UGC being suitable as the advertisement, publishing the UGC as the advertisement.

13. The non-transitory machine-readable medium of claim 12, wherein the operations further comprise gathering the feedback from a streaming service.

14. The non-transitory machine-readable medium of claim 12, wherein the operations further comprise gathering the feedback from a social media platform.

15. The non-transitory machine-readable medium of claim 12, wherein the advertisement is published to a video on demand service.

16. The non-transitory machine-readable medium of claim 12, wherein the advertisement is published to a social media platform.

17. The non-transitory machine-readable medium of claim 12, wherein the operations further comprise providing a reward to a user creating the UGC.

18. The non-transitory machine-readable medium of claim 12, wherein the processing system comprises a plurality of processors operating in a distributed computing environment.

19. The non-transitory machine-readable medium of claim 12, wherein the feedback is derived from market testing.

20. A method, comprising:
generating, by a processing system including a processor, a solicitation for acquiring an advertisement for a brand, wherein the solicitation meets a policy associated with the brand to which the advertisement is related;
posting, by the processing system, the solicitation;
receiving, by the processing system, user generated content (UGC) responsive to the solicitation;
receiving, by the processing system, feedback concerning the UGC, wherein the feedback comprises user generated comments from one or more of a streaming service and a social media platform;
determining, by the processing system, whether the UGC would be suitable as an advertisement based on the feedback; and
responsive to the UGC being suitable as the advertisement, publishing, by the processing system, the UGC as the advertisement.
